(19) United States
(12) Patent Application Publication
(10) Pub. No.: US 2004/0005445 A1
(43) Pub. Date: Jan. 8, 2004

(54) Colored multi-layer films and decorative articles made therefrom

(76) Inventors: David T. Ou Yang, Woodbury, MN (US); Ronald J. Kopicz, Berwick, PA (US)

Correspondence Address: Thomas J. Durling, DRINKER BIDDLE & REATH LLP, One Logan Square, 18th & Cherry Streets, Philadelphia, PA, 19103-6996, US

(21) Appl. No.: 10/307,178

(22) Filed: Nov. 29, 2002

Related U.S. Application Data
(60) Provisional application No. 60/393,146, filed on Jul. 2, 2002.

(51) Int. Cl. B32B 7/02

(52) U.S. Cl. 428/212; 428/4

(57) ABSTRACT

The present invention is a multi-layer film coated or printed on at least one side with a dye-based or pigment-based colorant, which can be transparent, metallic, or high gloss opaque. The printed, multi-layered film can be used for gift packaging in the form of sheets, ribbons, bows, and for decorative articles such as garlands and lampshades.

### CROSS-REFERENCE TO RELATED APPLICATION

The present application claims priority from U.S. Provisional Application Serial No. 60/393,146, filed Jul. 2, 2002, which is incorporated herein by reference in its entirety.

### FIELD OF THE INVENTION

The invention relates to the field of decorative articles, and particularly to decorative articles formed from polymer films.

### BACKGROUND OF THE INVENTION

In order to tailor specific polymer properties to fit the end application, a polymer is usually modified by one or more techniques: co-polymerization, blending, rubber compounding, and formulation with different types of additives such as fillers, plasticizers, and stabilizers. However, no single polymer film can always meet the end-use needs. Layered polymeric films have therefore been developed to provide specific end-use characteristics useful in packaging, decoration, and other industrial applications: barrier, toughness, heat seal ability, and chemical resistance.

There are many conventional ways to prepare layered polymeric films. Coating and lamination are examples. In response to the need for desired end-use properties in a product, the last forty years has yielded development in various multi-layer film co-extrusion technologies that combine two or more, often up to six, polymers by high pressure and high temperature melt fabrication. Currently, some co-extruded film is being made that has an individual layer thickness shorter than the wavelength of light that can approach molecular dimensions as described by W. Schreak in U.S. Pat. No. 5,316,703 and 3,884,606.

Often, polymeric film is vacuum metalized with a thin layer of reflective metal, such as aluminum, to provide an optical effect. However, disadvantages of this type of reflective film are well known. The metal coating is easily chipped or flaked away, corrosive at high temperature and high humidity, and environmentally unfriendly.

Based on the theory of constructive interference of light, T. Alfrey, Jr., et al, in U.S. Pat. No. 3,711,176 stated that a multi-layered thin film, coextruded with repeated two or more polymeric layers, can reflect ultraviolet, visible, or infrared portions of the electromagnetic spectrum. Each of the polymeric diverse thin layers has a thickness within the range of 30 to 500 nm. Each interface between the diverse layers, which differ significantly in their refractive indices, can cause constructive reflective interference which results in the iridescent reflective effect in light waves. The film's iridescent reflective effects have enormous potential usage in the packaging and decorative industries. However, such film has a very narrow reflective wavelength, non-uniform color streaks, and spots across its entire surface.

J. A. Redford, et al., “Reflectivity of Iridescent Co-extruded Multi-layered Film,” Polymer Engineering and Science, Vol. 13, No. 3 (May, 1973), teaches that a more uniform and highly reflective film can be produced by using a linear layer thickness gradient in a multi-layer optically thin film.

U.S. Pat. No. 5,451,449 to R. S. Shetty, et al., discusses that one can enhance or modify the reflective or transmitted color of a multi-layer iridescent film by incorporating a transparent dye, which is soluble in thin polymeric layer(s), into the core inner layer(s) or skin layer(s). However, this method also has several disadvantages. The resulting film still has non-uniform color of streaks and spots. The amount and solubility of the dye, and its high temperature resistance characteristics toward the extrusion process (200 degrees C.) is critical. Further, pigment cannot be used due to either inefficient color strength or extrusion process problems. Also, there is a high process cost due to the waste developed in each color change process.

R. S. Shetty, et al., in U.S. Pat. No. 5,837,359 again described that one can produce a non-glossy and satin-look film with a haze level greater than or equal to 20 by incorporating pearlescent pigment in at least one of the layers in a multi-layer film co-extrusion. Again, the technique produces film with non-uniform color of streaks and spots and a less bright and glossy surface. The process cost is also high, especially during the color change process.

Therefore, a need exists for a decorative film with either enhanced or modified uniform reflective color.

### SUMMARY OF THE INVENTION

The present invention is a multi-layer film coated or printed on at least one side with a dye-based or pigment-based colorant, which can be transparent, metallic, or high gloss opaque. The printed, multi-layered film can be used for gift packaging in the form of sheets, ribbons, bows, and for decorative articles such as garlands and lampshades.

### BRIEF DESCRIPTION OF THE DRAWINGS

For the purpose of illustrating the invention, there are shown in the drawings forms which are presently preferred; it being understood, that this invention is not limited to the precise arrangements and instrumentalities shown.

FIG. 1 is a schematic cross-section of a printed two component multi-layer polymeric film according to the present invention.

FIG. 2 is a graph of The Commission International d'Eclairage (“CIE”) color scale using values of L*, a* and b* for color comparison.

FIG. 3 is a color comparison of a multi-layer film before and after it was printed with transparent ink, as measured from the printed side of the film.

FIG. 4 is a color comparison of the multi-layer film of FIG. 3 before and after it was printed with transparent ink, as measured from the non-printed side of the film.

FIG. 5 is a color comparison of a multi-layer film before and after it was printed with transparent ink and embossed with grand prix embossing pattern, as measured from the printed side of the film.

FIG. 6 is a color comparison of the multi-layer film of FIG. 5 before and after it was printed with transparent ink and embossed with grand prix embossing pattern, as measured from the non-printed side of the film.

FIG. 7 is a color comparison of a multi-layer film before and after it was printed with metallic ink, as measured from the printed side of the film.

FIG. 8 is a color comparison of the multi-layer film of FIG. 7 before and after it was printed with metallic ink, as measured from the non-printed side of the film.

FIG. 9 is a color comparison of a multi-layer film before and after it was printed with metallic ink and embossed with grand prix embossing pattern, as measured from the printed side of the film.

FIG. 10 is a color comparison of the multi-layer film of FIG. 9 before and after it was printed with metallic ink and embossed with grand prix embossing pattern, as measured from the non-printed side of the film.

FIG. 11 depicts a bow formed from printed film in accordance with the present invention.

FIG. 12 depicts a package wrapped in gift-wrap formed from printed film in accordance with the present invention.

FIG. 13 depicts a string of garland formed from printed film in accordance with the present invention.

FIG. 14 depicts a lampshade formed from printed film in accordance with the present invention.

### DETAILED DESCRIPTION OF THE PREFERRED EMBODIMENTS

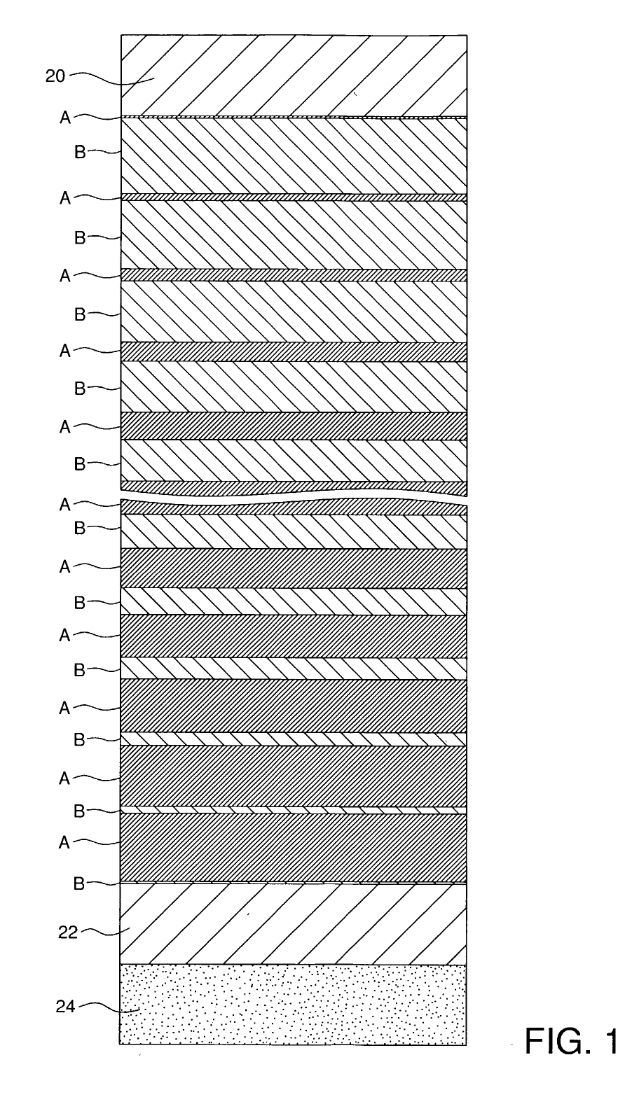

In the drawings, in which like numerals indicate like elements, there is shown a printed film according to the present invention, comparative color scales of the film and decorative articles made from the film. FIG. 1 shows a schematic cross section through the multi-layer film. The film is formed from co-extruded alternating layers of high refractive index polymer A and low refractive index polymer B, which have refractive indices of N_{A} and N_{B}, respectively. The difference in refractive indices of polymer A and polymer B is at least 0.03, and preferably more than 0.06. The film is oriented in the down (direction of extrusion) and across the web (direction normal to that of extrusion) directions in a ratio of at least 2:1, preferably in a ratio of 2.5:1 or more.

To obtain a substantially uniform reflective spectrum and to achieve a broad bandwidth of wavelength in the range of about 400 to 700 nm (i.e. in the visible light range), the multi-layer film has a linear gradient of optical layer repeat unit thickness. That is, the layers of polymer A are thick relative to those of polymer B at one side of the film, and decrease in thickness toward the second side of the film. In contrast, the layers of polymer B increase across the thickness of the film from the first to the second side. Thus, the layers of polymer B are thick relative to those of polymer A at the second side.

For clarity, FIG. 1 is schematic in that the layers of the film are not shown in proper proportion to the skin layers 20 and 22 or to one another. The individual layers of the film are actually very thin, preferably in the range of about 30 to 500 nm. Also, FIG. 1 is cut in the middle so that not all of the layers are shown. In fact, the total number of layers in the inner core of the film is at least 200 and preferably between 240 and 440 layers. Thus, the actual change in layer thickness from one repeat unit to the next is exaggerated in FIG. 1.

The reflected wave length for such an A/B multi-layer film can be calculated as follows:

λ_{M}=(2/M)(N_{A} d_{A}+N_{B} d_{B})

where M is the order of reflection (1,2,3 . . . ), N is the refractive index, and d is the layer thickness.

For a multi-layer film with three or more types of polymeric material (repeat units of A, B, C, etc.) the reflective wave length can be calculated as follows:

$${λ}_{M} = ( 2 / M ) {\sum }_{i = 1}^{j} {N}_{i} \cdot {d}_{i}$$

where j is the number of types of polymeric materials.

The amount of reflected light at each interface is determined by the difference in refractive indice and is calculated as follows:

$$R = {[ \frac{( {N}_{A} - {N}_{B} )}{( {N}_{A} + {N}_{B} )} ]}^{2}$$

The skin layers 20 and 22, which are provided to protect the core layers from scratching and weathering, can be formed from polymer A or polymer B. It is also possible to use a third polymer, polymer C, that has a reflective index, N_{C}, that is between N_{A} and N_{B}. The skin layers 20, 22 may make up as much as 20% of the total thickness of the film, and are substantially optically inactive. The total thickness of the film, including the skin layers, is at least 0.6 mil (15 microns), and preferably between 1.5 mil and 5.0 mil.

Typical examples of A and B layers are polyethylene terephthalate (PET) and polymethyl methacrylate (PMMA). The two have refractive indices of N_{PET}:1.57 and N_{PMMA}:1.49. The skin layers can be composed of PET, PMMA or polybutylene terephthalate (PBT). PBT can also be used in place of PET as the high refractive index polymer. Examples of other materials for forming the high refractive index polymeric layers include glycol modified PET (PETG), polycarbonate (PC), polystyrene (PS), polyethylene naphthalate (PEN), etc. Examples of alternative low refractive index polymeric layers include polyethylene vinyl acetate (EVA), polypropylene (PP), ionomer, etc. The preferred films are formed from 250 layers of alternating PET and PMMA sandwiched by skin layers of PET, thereby having the structure PET/(PET/PMMA)₁₂₅/PET. Such multi-layer films are commercially available from Minnesota Mining and Manufacturing, St. Paul, Minn. (3M) under the trade names CM500 and CM 590. Further multi-layer films are described in U.S. Pat. No. 3,711,176, which is incorporated herein by reference.

The film is printed on at least one side with a continuous layer of colorant 24. The colorant can be printed or coated by using any conventional process such as flexographic, gravure, letter press, screen, digital printing and the like. Alternatively, the colorant can be coated by low temperature hot melt coating or low temperature extrusion. The colorant can also be flood printed, strip printed, or printed with specific patterns.

The colorant is selected based on several criteria. In one embodiment, the colorant is transparent ink having a coloring agent, a carrier and a binder. All three components are selected so that the index of refraction of each component closely matches the others. Good results are obtained when the respective indices of refraction of the coloring agent, carrier and binder are within 0.02 of one another. Particle size of the coloring agent is another criterion. Coloring agent having a particle size of less than 7 microns are well suited to achieve the desired effect. Preferably, coloring agent particle size is less than 0.7 micron. Presently, organic pigments are preferred for their resistance to water and ultraviolet light. By way of example, the pigment can be barium lithol, calcium lithol or the like. Examples of appropriate binders are acrylic resin, gum resins or blends thereof. The carrier can be water or solvent. A preferred transparent ink is water based Flink ink 1015 produced by Flink Ink Corporation, Ann Arbor, Mich. It has a viscosity of 15 to 18 seconds measured by a number three Zahn Cup viscometer. The pH value of the ink is about 9.0 to 9.4. Examples of films produced with Flink ink 1015 are described below.

In another embodiment, the film is printed with a metallic ink. Suitable metallic inks include a colorant, a binder, a carrier and metal flakes. The colorant, binder and carrier can be selected as described above in connection with the transparent ink. The metal flakes can be any metal suitable for imparting a metallic appearance to the film, such as copper for a gold-like color, or aluminum for a silver-like color. Although dependent on the metal chosen, it has been found that inks with a metal content of between 10 and 40 percent by weight produce suitable products. One suitable ink is Flink metallic ink 8643, available from Flink Ink Corporation.

In another embodiment, the film is printed with a high gloss opaque ink. Suitable inks have a smooth surface to provide high reflectivity and high gloss. To provide the required properties of high gloss and high opacity, high refractive index additives can be added to the ink. For example, 15-25 percent by weight of titanium oxide or clay be added.

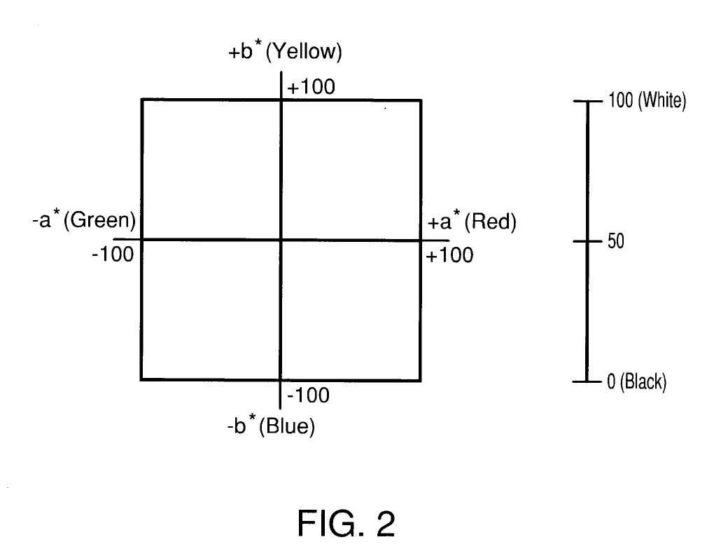

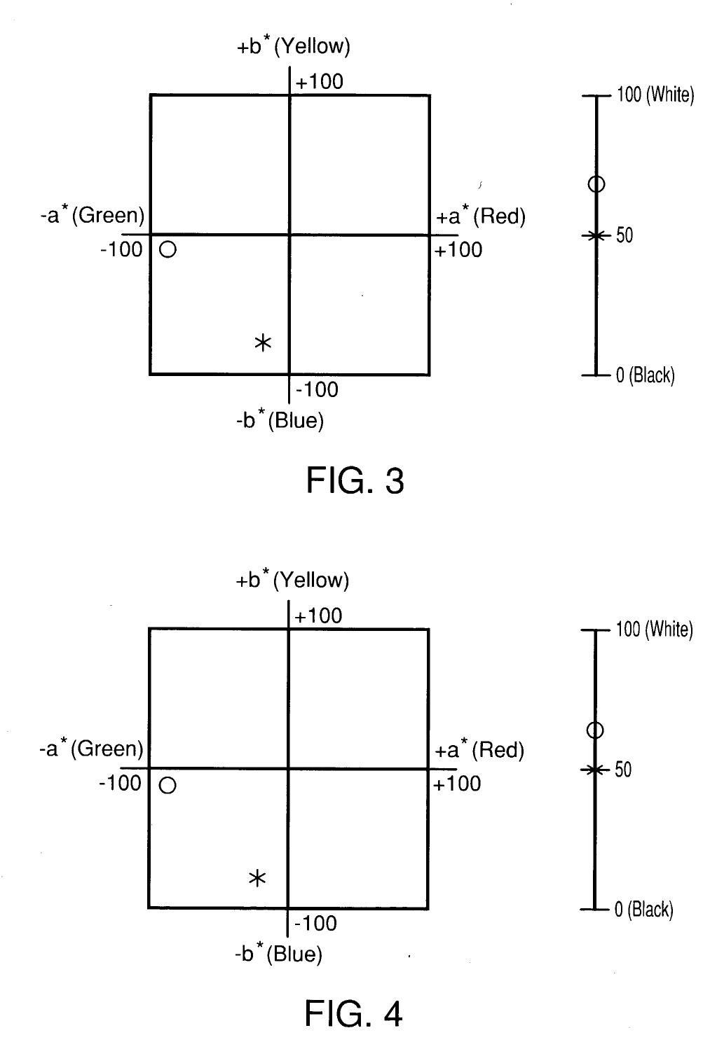

By selecting an appropriate colorant in accordance with the guidelines set forth above, the color qualities of the film can be greatly enhanced. The color can be quantified using the Commission International d'Eclaiage (“CIE”) color scale, which is shown in FIG. 2. In the CIE color scale, the values L*, a* and b* collectively describe the color characteristics of an object. On the right hand side of the CIE, the value of L* represents the lightness of color, 0 representing black color, 100 representing white color, and a range from 0 to 100 representing various degrees of gray color. On the horizontal axis of the left portion of the CIE, a positive a* value represents red color, while a negative a* value represents green color. On the vertical axis, positive b* values represent yellow color, and negative b* values represent blue color. The absolute value of the number represents the strength of the color. In FIGS. 3-10, values representing printed films are plotted as “o”. For purposes of comparison, values of the unprinted film are plotted as “*”.

As shown in more detail in the examples below, unprinted film is mainly a blue shade. However, once the film is printed with different transparent inks or different metallic inks according to the present invention, the reflective color can be controlled to provide a variety of vivid colors as demonstrated in FIGS. 3-10 and in the examples.

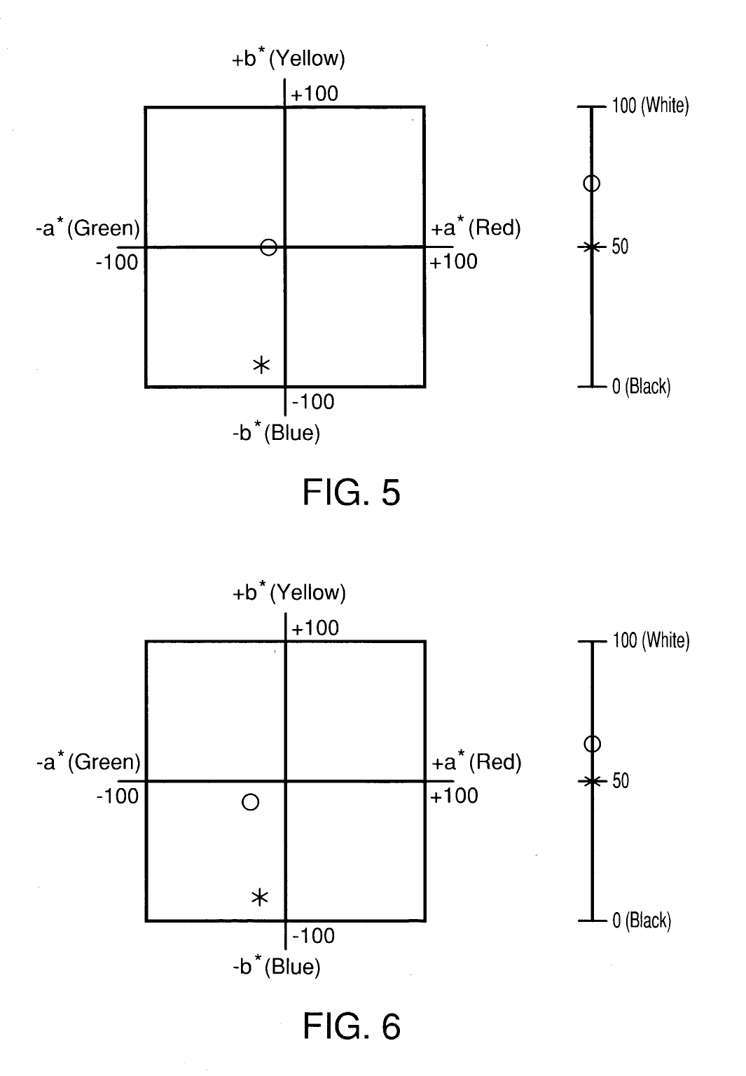

The colored multi-layered films can be further modified by embossing, texturing or other surface modification techniques. The patterns arranged on both sides of the film surface can cause reflection and transmission phenomena to occur many times on the same side of the film surface. A completely different and vivid color with different lightness and chroma can be obtained. The effects of embossing to the CIE color scale is shown in FIGS. 5, 6, 9, 10 and the examples below. The colored multi-layer film can also be modified by texturing, abrasing or other techniques.

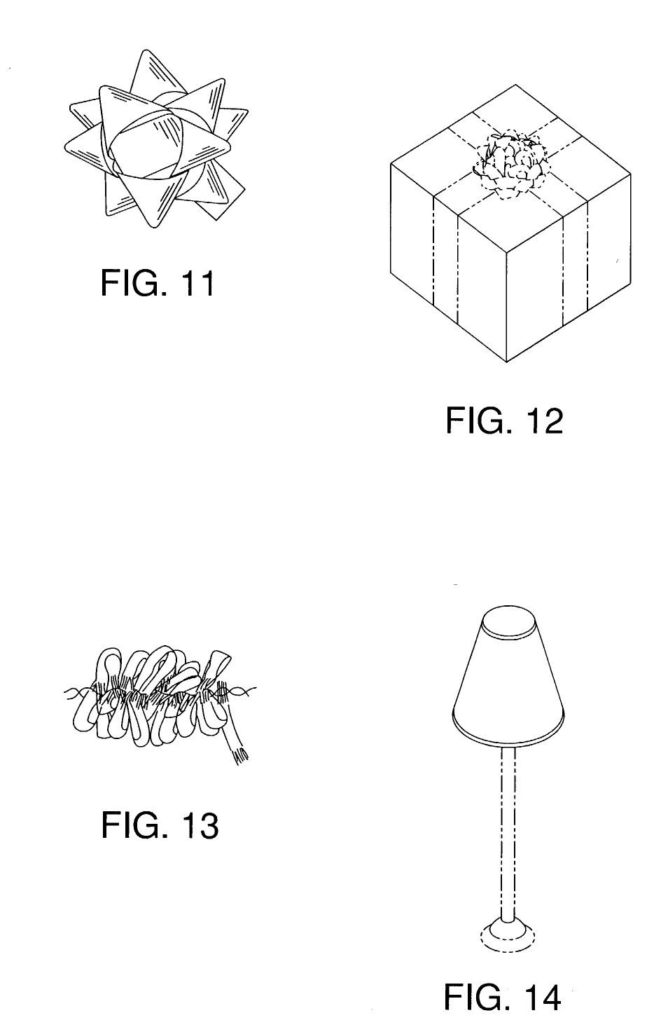

A bow as shown in FIG. 11 can be made by slitting the printed film down to 1.9 cm wide and using a Ragen bow machine to form a bow with a plurality of loops. Such a bow can be formed from colored film printed with transparent ink, metallic ink or an opaque coating. When forming the bow, it is preferred to form the bow loops with the printed side of the film on the inside of the loops. Thus, the color from the outside of the bow is modified by the reflection of the color printed on the inside of the bow film, as well as by the color transmitted through the film from the inside to the outside. The color of the inside of the film is dominantly modified by the reflection of this color and also by the reflected light from each interface which had first passed and filtered through the color ink layer and then passed through the color ink layer for a second time before being viewed by the observer. The end result is a bow that looks much more colorful than conventional bows. Not only does the outside of the bow show vivid color at different viewing angles, but the inside of the bow shows an especially strong reflection of this specific color as well. This makes the overall appearance of the bow colorful and lively.

Colored film with transparent, metallic or opaque colorant can be used to make a variety of decorative articles. FIG. 12 shows gift-wrap for a package made from colored film. In the drawing, the gift-wrap is adorned with a conventional bow and ribbon shown in broken lines. However, colored films in accordance with the present invention could instead be used to make the bow and ribbon, as well as the gift-wrap shown in the drawing. Additional examples of decorative articles that can be made with the film described herein include bags (not shown), garland, shown in FIG. 13, and a lampshade as shown in FIG. 14. One method of making garland from a sheet of plastic film is described in U.S. Pat. No. Re. 35,897 to Protz, Jr., which is hereby incorporated by reference. The lampshade shown in FIG. 14 can be made by cutting a sheet of a colored film, wrapping the film to form a shell with juxtaposed side edges, and supporting the top and bottom edges with a rigid frame. The preferred shape of the cut is an annular sector. Such a sector is defined by two concentric arcs having first and second radii and a common center and radial lines connecting the arc ends. Once cut, the annual sector can be wrapped by juxtaposing the radial lines to form a conical section which can then be supported by a pair of circular frames as shown in FIG. 14. Of course, lampshades of different configurations, such as truncated pyramids, can also be formed by replacing the arcs with segmented edges, juxtaposing the side edges and supporting the resulting structure with polygonal frames.

### EXAMPLES

One side of 3M CM 590 film was printed with Flink ink 1015 with an anilox roller of 500 lines per 2.54 cm at a web speed of 70 meters per minute by using a Roto Press machine, Model No. 2002, manufactured by Roto Press Engineering Co., Inc., Ohio. The color of the printed film was measured with a Spectro Eye™ Spectro Photometer, manufactured by Gretag Macbeth™, Switzerland. The results of the color analysis of the printed side of the film are shown in FIG. 3 using the CIE color scale. The CIE values of the film printed with Flink ink 1015 are plotted with the symbol “o”. For comparison, the symbol “*” represents unprinted film. Table 1 lists the actual values represented in FIG. 3, as well as the CIE color scale of films prepared with several different transparent inks.

TABLE 1
THE CIE COLOR SCALE OF TRANSPARENT INK
PRINTED MULTI-LAYER FILM - PRINTED SIDE
OF FILM

| Printed Film (s) | CIE | COLOR | SCALE |
|---|---|---|---|
| (3M CM 590) | L* | a* | b* |
| Non-printed (comparative example) | 50.83 | −26.22 | −75.88 |
| Printed with Flink Ink 1015 | 70.78 | −84.10 | −5.67 |
| Printed with Flink Ink 1001 | 93.83 | 1.33 | 0.50 |
| Printed with Flink Ink 1029 | 47.85 | −64.15 | −17.60 |
| Printed with Flink Ink 1003 | 62.93 | −61.81 | −49.84 |
| Printed with Flink Ink 1041 | 31.50 | 44.64 | −76.34 |

FIG. 4 shows the CIE color scale of the non-printed side of the colored film prepared with Flink ink 1015. Like FIG. 3, the printed film values are plotted with the symbol “o” while values for unprinted film are represented with the symbol “*”. Table 2 shows the CIE color scale values of the non-printed side of the films listed in Table 1.

TABLE 2
THE CIE COLOR SCALE OF TRANSPARENT INK
PRINTED MULTI-LAYER FILM - NON-PRINTED

SIDE OF FILM.

| Printed Film (s) | CIE | COLOR | SCALE |
|---|---|---|---|
| (3M CM 590) | L* | a* | b* |
| Non-printed (comparative example) | 51.21 | −29.18 | −73.38 |
| Printed with Flink Ink 1015 | 67.16 | −85.66 | −8.61 |
| Printed with Flink Ink 1001 | 64.49 | −60.73 | −54.31 |
| Printed with Flink Ink 1029 | 44.15 | −70.39 | −22.42 |
| Printed with Flink Ink 1003 | 58.60 | −54.67 | −55.90 |
| Printed with Flink Ink 1041 | 23.41 | 49.60 | −88.94 |

FIG. 5 shows the CIE color scale of the printed side of 3M CM 590 film printed with Flink ink 1015 and embossed with a grand prix pattern as compared to unprinted film. Table 3 lists CIE color scale values for colored films embossed and printed with several transparent inks.

TABLE 3
THE CIE COLOR SCALE OF TRANSPARENT INK
PRINTED AND EMBOSSED WITH GRAND PRIX
PATTERN - PRINTED SIDE OF FILM

| Printed & Embossed Film (s) | CIE | COLOR | SCALE |
|---|---|---|---|
| (3M CM 590) | L* | a* | b* |
| Non-printed/ | 50.83 | −26.22 | −75.88 |
| Non-embossed (comparative example) | | | |
| Printed with Flink Ink 1015 | 73.35 | −17.51 | 0.01 |
| and embossed | | | |
| Printed with Flink Ink 1001 | 91.75 | 0.18 | −1.10 |
| and embossed | | | |
| Printed with Flink Ink 1029 | 52.21 | −29.98 | −4.20 |
| and embossed | | | |
| Printed with Flink Ink 1003 | 64.67 | −32.87 | −45.48 |
| and embossed | | | |
| Printed with Flink Ink 1041 | 40.39 | 56.64 | −61.30 |
| and embossed | | | |

FIG. 6 shows the CIE color scale of the non-printed side of the colored film prepared with Flink ink 1015 and embossed, as compared with unprinted film. Table 4 shows the CIE color scale values of the non-printed side of the films listed in Table 3.

TABLE 4
THE CIE COLOR SCALE OF TRANSPARENT INK
PRINTED AND EMBOSSED WITH GRAND PRIX
PATTERN - NON-PRINTED SIDE OF FILM

| Printed & Embossed | | | |
|---|---|---|---|
| Film (s) | CIE | COLOR | SCALE |
| (3M CM590) | L* | a* | b* |
| Non-printed & | 51.21 | −29.18 | −73.38 |
| non-embossed (comparative example) | | | |
| Printed with Flink Ink 1015 | 67.79 | −26.69 | −9.95 |
| and embossed | | | |
| Printed with Flink Ink 1001 | 81.43 | −29.87 | −19.70 |
| and embossed | | | |
| Printed with Flink Ink 1029 | 73.86 | −12.38 | 27.40 |
| and embossed | | | |
| Printed with Flink Ink 1003 | 74.78 | −5.16 | −28.21 |
| and embossed | | | |
| Printed with Flink Ink 1041 | 62.42 | 31.06 | −21.48 |
| and embossed | | | |

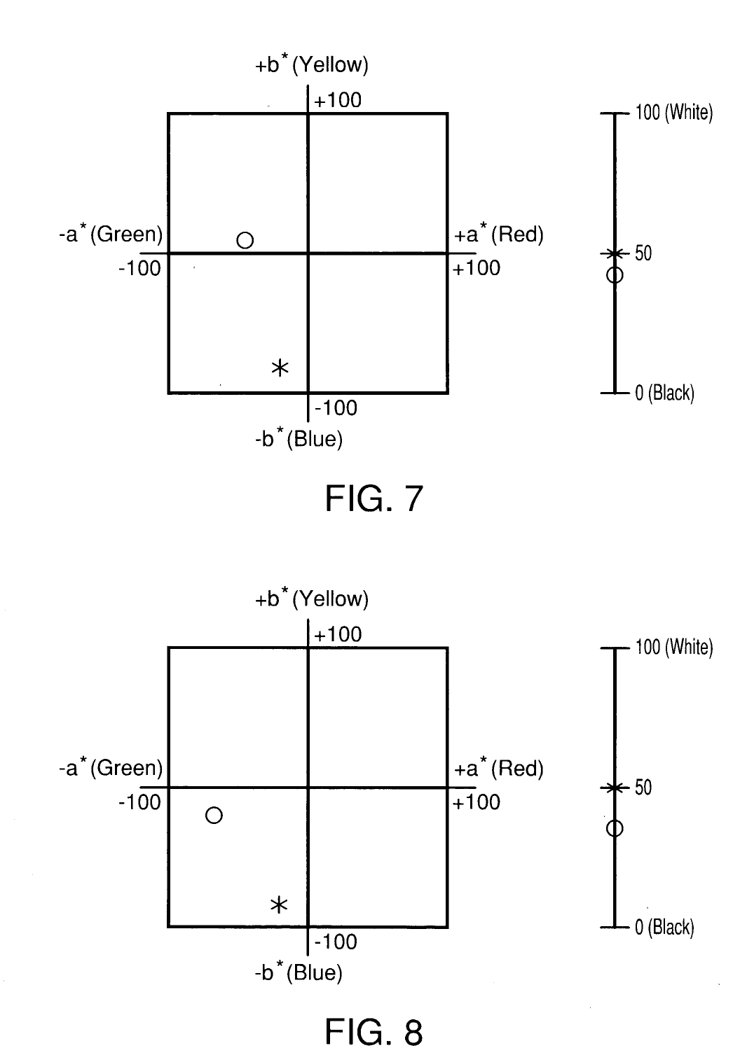

FIG. 7 shows the CIE color scale of the printed side of 3M CM 590 film printed with metallic Flink ink 8643 as compared to unprinted film. Table 5 lists CIE color scale values for the colored side of films printed with several metallic inks.

TABLE 5
THE CIE COLOR SCALE OF METALLIC INK
PRINTED MULTI-LAYER FILM - PRINTED
SIDE OF FILM

| Printed Film (s) | CIE | COLOR | SCALE |
|---|---|---|---|
| (3M CM590) | L* | a* | b* |
| Non-printed (comparative example) | 50.83 | −26.22 | −75.88 |
| Printed with Flink Ink 8643 | 45.30 | −33.90 | 9.93 |
| Printed with Flink Ink 8922 | 42.53 | −21.23 | −22.38 |
| Printed with Flink Ink 8703 | 42.37 | −66.91 | 13.05 |
| Printed with Flink Ink 8842 | 22.19 | 35.15 | −49.56 |
| Printed with Flink Ink 8040 | 33.56 | 17.17 | −55.14 |

FIG. 8 shows the CIE color scale of the non-printed side of the colored film prepared with metallic Flink ink 8643, as compared with unprinted film. Table 6 shows the CIE color scale values of the non-printed side of the films listed in Table 5.

TABLE 6
THE CIE COLOR SCALE OF METALLIC INK
PRINTED MULTI-LAYER FILM - NON -PRINTED
SIDE OF FILM

| Printed Film(s) | CIE | COLOR | SCALE |
|---|---|---|---|
| (3M CM590) | L* | a* | b* |
| Non-printed (comparative example) | 51.21 | −29.18 | −73.38 |
| Printed with Flink Ink 8643 | 33.43 | −57.22 | −14.13 |
| Printed with Flink Ink 8922 | 27.48 | −51.31 | −5.67 |
| Printed with Flink Ink 8703 | 36.31 | −67.68 | −5.30 |
| Printed with Flink Ink 8842 | 18.29 | 27.25 | −60.30 |
| Printed with Flink Ink 8040 | 28.32 | 22.12 | −75.67 |

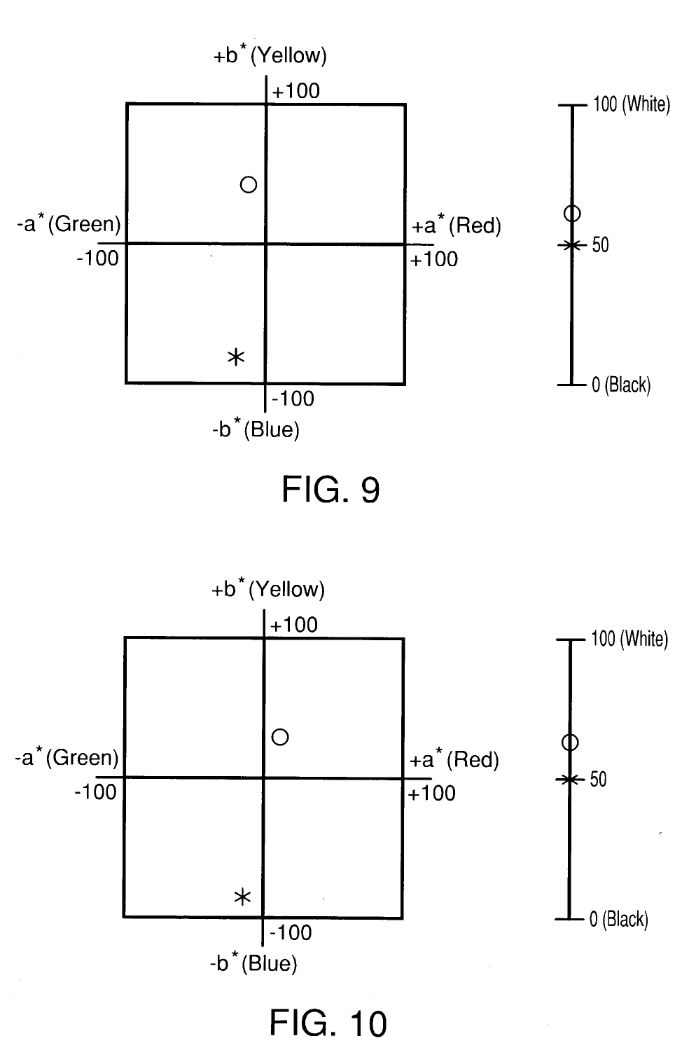

FIG. 9 shows the CIE color scale of the printed side of 3M CM 590 film printed with metallic Flink ink 8643 and embossed with a grand prix pattern as compared to unprinted film. Table 7 lists CIE color scale values for colored films embossed and printed with several metallic inks.

TABLE 7
THE CIE COLOR SCALE OF METALLIC INK
PRINTED AND EMBOSSED WITH GRAND PRIX
PATTERN - PRINTED SIDE OF FILM

| Printed & Embossed Film (s) | CIE | COLOR | SCALE |
|---|---|---|---|
| (3M CM590) | L* | a* | b* |
| Non-printed, | 50.83 | −26.22 | −75.88 |
| non embossed (comparative example) | | | |
| Printed with Flink Ink 8643 | 62.60 | −2.38 | 38.19 |
| Printed with Flink Ink 8922 | 70.76 | 34.32 | 74.76 |
| Printed with Flink Ink 8703 | 42.25 | −50.94 | 20.85 |
| Printed with Flink Ink 8842 | 36.47 | 50.63 | −27.06 |
| Printed with Flink Ink 8040 | 40.13 | 28.63 | −43.66 |

FIG. 10 shows the CIE color scale of the non-printed side of the colored film prepared with metallic Flink ink 8643 and embossed, as compared with unprinted film. Table 8 shows the CIE color scale values of the non-printed side of the films listed in Table 7.

TABLE 8
THE CIE COLOR SCALE OF METALLIC INK PRINTED
AND EMBOSSED WITH GRAND PRIX
PATTERN - NON-PRINTED SIDE OF FILM.

| Printed and Embossed | | | |
|---|---|---|---|
| Film (s) | CIE | COLOR | SCALE |
| (3M CM590) | L* | a* | b* |
| Non-printed, | 51.21 | −29.18 | −73.38 |
| non-embossed (comparative example) | | | |
| Printed with Flink Ink 8643 | 64.76 | 4.12 | 34.08 |
| Printed with Flink Ink 8922 | 50.66 | −0.51 | 36.83 |
| Printed with Flink Ink 8703 | 69.82 | −2.26 | 53.83 |
| Printed with Flink Ink 8842 | 49.06 | 22.23 | −5.78 |
| Printed with Flink Ink 8040 | 83.09 | 43.43 | 10.90 |

As noted above, a variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A colored film for making decorative articles, the colored film comprising:
a multi-layered thermoplastic film having
a plurality of repeating units comprising at least two different polymeric film layers arranged in a linear gradient of optical layer repeated unit thickness, and
a skin layer on each side of the plurality of repeating units; and
a transparent ink on at least one of the skin layers.

2. The colored film of claim 1 wherein the transparent ink is a blend of coloring agent having a particle size of less than 7 microns, a carrier and a binder.

3. The colored film of claim 2 wherein the coloring agent has a particle size of less than 0.7 microns.

4. The colored film of claim 2 wherein the coloring agent, carrier and binder each have an index of refraction within 0.02 of one another.

5. The colored film of claim 1 wherein the transparent ink comprises a coloring agent, a carrier and a binder each having an index of refraction within 0.02 of one another.

6. The colored film of claim 1 wherein the transparent ink comprises an organic pigment, a carrier and a binder each having an index of refraction within 0.02 of one another.

7. The colored film of claim 1 wherein the film has a CIE color scale with an L* value greater than 55.

8. The colored film of claim 7 wherein the film has a CIE color scale with values of a* between −85 and 60, and b* between −80 and 40.

9. A colored film for making decorative articles, the colored film comprising:
a multi-layered thermoplastic film having
a plurality of repeating units comprising at least two different polymeric film layers arranged in a linear gradient of optical layer repeated unit thickness, and
a skin layer on each side of the plurality of repeating units; and
a metallic ink on at least one of the skin layers.

10. The colored film of claim 9 wherein the metallic ink comprises between about 10 and 40 percent by weight of metal flakes.

11. The colored film of claim 10 wherein the metallic ink further comprises a coloring agent having a particle size of less than 7 microns.

12. The colored film of claim 11 wherein the coloring agent has a particle size of less than 0.7 microns.

13. The colored film of claim 10 wherein the metallic ink further comprises a coloring agent, a carrier and a binder each having an index of refraction within 0.02 of one another.

14. The colored film of claim 9 wherein the film has a CIE color scale with an L* value greater than 55.

15. The colored film of claim 14 wherein the film has a CIE color scale values of a* between −70 and 60, and b* between −80 and 75.

16. A colored film for making decorative articles, the colored film comprising:
a multi-layered thermoplastic film having
a plurality of repeating units comprising at least two different polymeric film layers arranged in a linear gradient of optical layer repeated unit thickness, and
a skin layer on each side of the plurality of repeating units; and
an opaque coating on at least one of the skin layers.

17. The colored film of claim 16 wherein the opaque coating comprises between about 15 and 25 percent by weight of high refractive index additive.

18. The colored film of claim 17 wherein the high refractive index additive is selected from the group consisting of titanium oxide and clay.

19. A decorative bow comprising:
a colored film slit and formed into a plurality of loops, the colored film comprising a multi-layered thermoplastic film having
a core of repeating units comprising at least two different polymeric film layers arranged in a linear gradient of optical layer repeated unit thickness,
a first skin layer on a first side of the core,
a second skin layer on a second side of the core, and
a transparent ink printed on the first skin layer.

20. The decorative bow of claim 19 wherein the first skin layer is disposed on the inside of said loops.

21. The decorative bow of claim 20 wherein the transparent ink is a blend of coloring agent having a particle size of less than 7 microns, a carrier and a binder.

22. The decorative bow of claim 21 wherein the coloring agent, carrier and binder each have an index of refraction within 0.02 of one another.

23. The decorative bow of claim 20 wherein the transparent ink comprises a coloring agent, a carrier and a binder each having an index of refraction within 0.02 of one another.
